(19) United States
(12) Patent Application Publication
(10) Pub. No.: US 2007/0242849 A1
(43) Pub. Date: Oct. 18, 2007

(54) Loudspeaker with high power efficiency and low resonance frequency

(75) Inventor: Szu-Wei Sun, Kueishan Shiang, MN (US)

Correspondence Address: NIKOLAI & MERSEREAU, P.A., 900 SECOND AVENUE SOUTH, SUITE 820, MINNEAPOLIS, MN, 55402, US

(73) Assignee: Galax Multimedia Co., Ltd., Kueishan Shiang (TW)

(21) Appl. No.: 11/403,613

(22) Filed: Apr. 13, 2006

(51) Int. Cl. H04R 9/06; H04R 11/02; H04R 1/00

(52) U.S. Cl. 381/412; 381/420

(57) ABSTRACT

A loudspeaker with high power efficiency and low resonance frequency is achieved by having a damper directly or indirectly sleeving beside a coil on a voice coil so that gravity center of loudspeaker is low and stable and the voice coil does not dislocate easily to keep acoustic performance of the loudspeaker excellent without acoustic distortion and to shorten the length of the voice coil. Moreover, a U-yoke attaches a frame in form of an insertion combination to shorten the loudspeaker at joints. Thereby, the depth of the loudspeaker is significantly reduced in size.

### BACKGROUND OF THE INVENTION

1. Field of the Invention

The present invention relates to a loudspeaker with high power efficiency and low resonance frequency, and more particularly to a loudspeaker that improves in sensitivity and reduces acoustic distortion during operation.

2. Description of Related Art

With reference to FIG. 4, a conventional loudspeaker substantially comprises a U-yoke 30 attached to a frame 40 at a bottom thereof, a magnet mounted at a center of the U-yoke 30, a washer 37 sleeving the magnet 31, and a voice coil 33 surrounding the washer 37. The voice coil 33 has a coil 34 winding around thereon in a partial section near the U-yoke 30 so that a rest section of the voice coil 33 performs a mounting tube that is sleeved by a damper 32. The voice coil 33 has a top connecting to a cone 35 with edges 36.

Thereby, when the voice coil 33 of the loudspeaker vibrates, the voice coil 33 easily moves aside and is kept from bumping the U-yoke 30 or magnetic 31 and washer 37 by the edges 36 and the damper 32.

However, the damper 32 of the conventional loudspeaker is attached to the voice coil 33 at the position without the coil 34 (as shown in FIG. 4) so that the mounting tube must has a reserved length for attaching the damper 32. Therefore, the conventional loudspeaker has a long length (depth) that is caused by the voice coil 33 attachment and can not be avoided. Moreover, the damper 32 is arranged at an upper position on the voice coil 33 to flush with the bottom of the frame 40 so that the gravity center of the voice coil 33 is high and the loudspeaker is easily vibrated. Hence, acoustic distortion of the loudspeaker is occurred inherently.

### SUMMARY OF THE INVENTION

A main objective of the present invention is to provide a loudspeaker that has high power efficiency and low resonance frequency.

Another main objective of the present invention is to provide a loudspeaker that improves in sensitivity and reduces acoustic distortion during operation.

To achieve the foregoing objectives, the loudspeaker comprises:

a U-yoke with a cavity, a sidewall, a top face and a center within the cavity and having
a recess defined in the top face to communicate the cavity and to perform an edge near the top face as a stair; and
a magnet mounted at the center inside the cavity.

a voice coil sleeving the magnet;

a coil attached to the voice coil;

a damper attached between the voice coil and the sidewall of the U-yoke and received inside the recess to abut the stair; and

a frame mounted on the U-yoke.

By arranging the damper directly or indirectly sleeving beside the coil on the voice coil, the gravity center of the U-yoke is low and stable and the voice coil does not dislocate easily to keep acoustic performance of the loudspeaker excellent without acoustic distortion and to shorten the length of the voice coil.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a loudspeaker with high power efficiency and low resonance frequency in accordance with the present invention;

FIG. 2 is a cross-sectional side view of a preferred embodiment of the loudspeaker with high power efficiency and low resonance frequency;

FIG. 3 is cross-sectional side view of another preferred embodiment of the loudspeaker with high power efficiency and low resonance frequency; and

FIG. 4 is a cross-sectional side view of a conventional loudspeaker in accordance with the prior art.

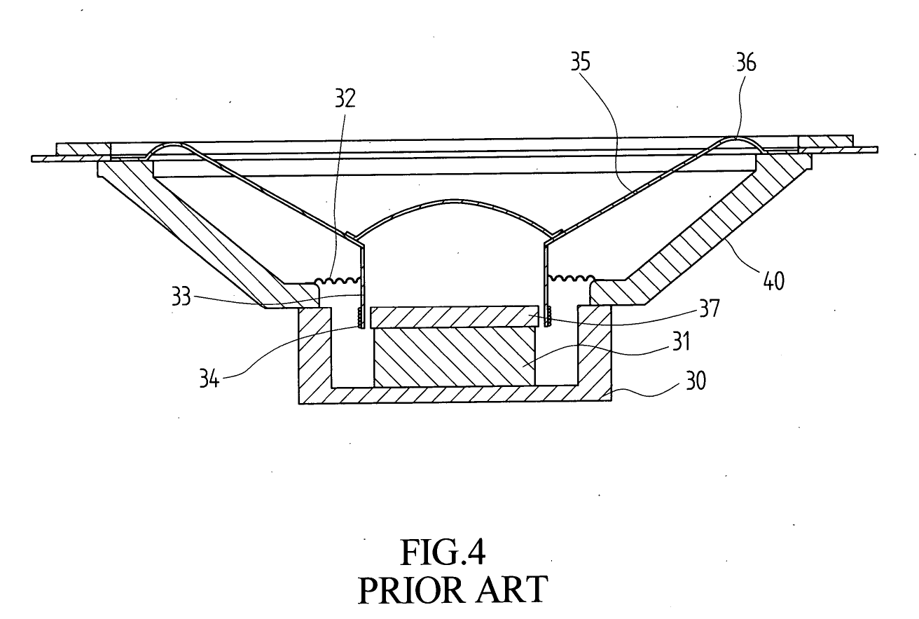

### DETAILED DESCRIPTION OF THE PREFERRED EMBODIMENT

A loudspeaker with high power efficiency and low resonance frequency in accordance with the present invention that has a damper directly or indirectly sleeving beside a coil on a voice coil so that gravity center of the voice coil is low and stable and the voice coil does not dislocate easily to keep acoustic performance of the loudspeaker excellent without acoustic distortion and to shorten the length of the voice coil. Moreover, a U-yoke attaches a frame in form of an insertion combination to shorten the loudspeaker at joints. Thereby, the depth of the loudspeaker is significantly reduced in comparison with the conventional one.

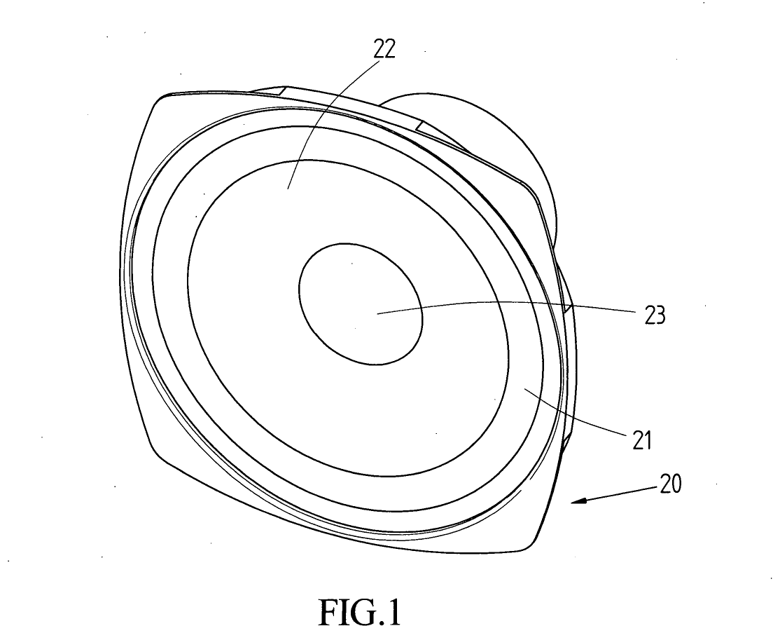

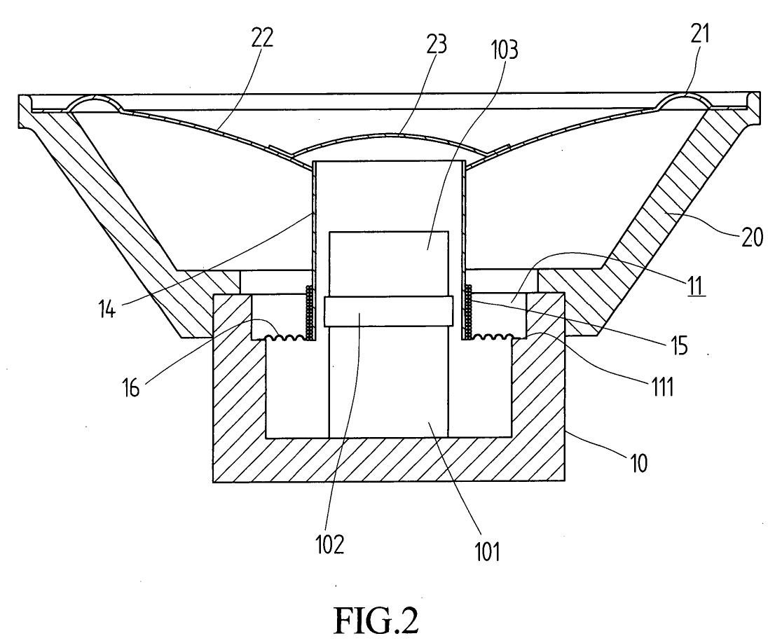

With reference to FIGS. 1 and 2, a preferred embodiment of the loudspeaker with high power efficiency and low resonance frequency substantially comprises a U-yoke 10 and a frame 20.

The U-yoke 10 has a cavity, a sidewall, a top face and a recess 11 defined in the top face to communicate with the cavity and to make an edge near the top face have a stair 111. The U-yoke 10 has a center within the cavity, a magnet 101 mounted at the center, a washer 102 mounted on the magnet 101 and a sub-magnet 103 further mounted on the washer 102. The sub-magnet 103 provides extra magnetic force to enlarge magnetic loop distance and to improve sensitivity of the loudspeaker.

Moreover, the magnet 102 is partially coiled at its top with a voice coil 14 that has a lower end and a coil 15 attached to the lower end of the voice coil 14. The coil 15 is coated with thermal-resistant glue to make a damper 16 mount around the coil 15. The damper 16 is particularly received inside the recess 11 until the damper 16 abuts the stair 111.

The frame 20 is cone-shaped and has a narrow bottom, a wide top, a cone 22, a rim 21 and a dust cover 23. The narrow bottom of the frame 20 has a circular cutout defined therein to correspondingly and partially receive the U-yoke 10 near the top face so that a total height of the loudspeaker is reduced. The rim 21 has an outer side attached to the wide top of the frame 20 and an inner side connecting with the cone 22. The cone 22 is received inside the frame 20 and mounted on the voice coil 14. Moreover, the dust cover 23 is mounted on the cone 22 over the voice coil 14.

Thereby, when the voice coil 14 of the loudspeaker vibrates, the voice coil 14 is positioned by the rim 21 and the damper 16 so that the voice coil 12 has a stable gravity center and does not dislocate easily to reduce the acoustic distortion of the loudspeaker. When the voice coil 14 is combined with the damper 16 and has less vibration, resonance frequency is correspondingly reduced. Moreover, the damper 16 is attached around the coil 15 on the voice coil 14 and further received inside the recess 11 to position on the stair 111 so that the total length of the loudspeaker is significantly diminished. Additionally, arrangement of the magnetic 101 and the sub-magnetic 103 improves the sensibility of the loudspeaker.

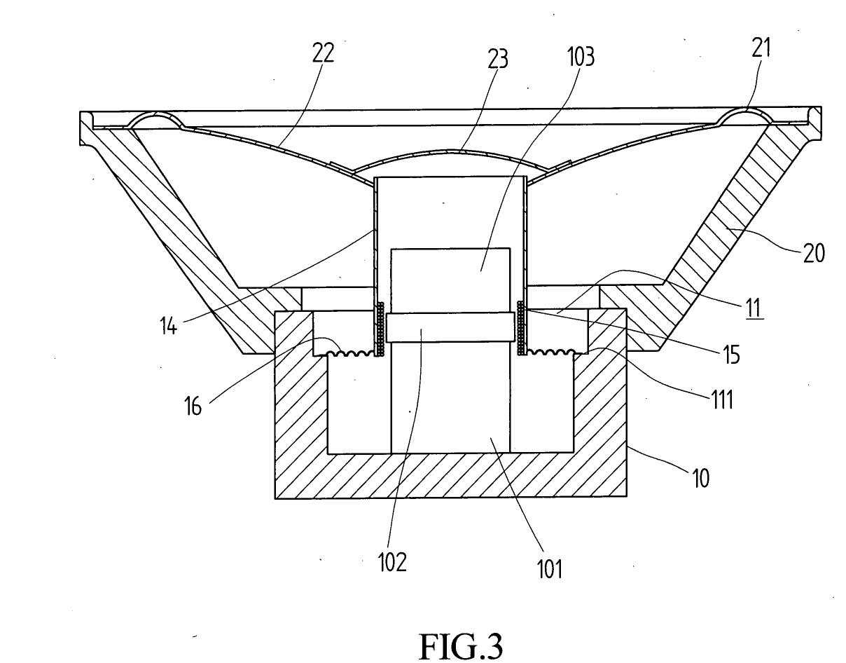

Furthermore, the damper 16 does not easily deteriorate and break at high temperatures caused by the coil 15 because the thermal-resistant glue is applied between the damper 16 and the coil 15. With regard to the thermal resistance problem, another preferred embodiment is provided as shown in FIG. 3 in which the coil 15 is attached inside the voice coil 14. By isolating the thermal of the coil 15 with the voice coil 14, the damper 16 does not easily deteriorate and break even the coil 15 generates the high temperatures.

Because the damper 16 is attached beside the coil 15 directly or indirectly, the voice coil 14 is shortened without reserving the mounting tube for attaching the damper as shown in the conventional loudspeaker. Therefore, the loudspeaker enables to downsize without lowering acoustic quality.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A loudspeaker with high power efficiency and low resonance frequency comprises:
a U-yoke with a cavity, a sidewall, a top face and a center within the cavity and having
a recess defined in the top face to communicate with the cavity and to perform an edge near the top face as a stair; and
a magnet mounted at the center inside the cavity.
a voice coil sleeving the magnet;
a coil attached to the voice coil;
a damper attached between the voice coil and the sidewall of the U-yoke and received inside the recess to abut the stair; and
a frame mounted on the U-yoke.

2. The loudspeaker as claimed in claim 1, wherein the frame is cone-shaped with a narrow bottom and a wide top and has:
a circular cutout defined at the narrow bottom to partially receive the U-yoke near the top face of the U-yoke;
a rim having an inner side and an outer side mounted on the wide top of the frame;
a cone extending between the inner side of the rim and the voice coil; and
a dust cover mounted on the cone over the voice coil.

3. The loudspeaker as claimed in claim 1, wherein the U-yoke further has a washer mounted on the magnetic and a sub-magnet mounted on the washer.

4. The loudspeaker as claimed in claim 1, wherein the coil winds outside the voice coil;
wherein, the damper is directly attached to the coil by thermal-resistant glue.

5. The loudspeaker as claimed in claim 1, wherein the coil is attached inside the voice coil.
